(19) United States
(12) Patent Application Publication
(10) Pub. No.: US 2005/0198573 A1
(43) Pub. Date: Sep. 8, 2005

(54) System and method for translating web pages into selected languages

(75) Inventors: Riaz Ali, North York (CA); David O. Skura, Zephyr (CA); Siamak Safarian, Richmond Hill (CA); Randy K. May, Barrie (CA); Fariba Haghighi, North York (CA); Naveed Khaliq, Markham (CA)

Correspondence Address: James M. Stover;Intellectual Property Section, Law Department, NCR Corporation, 1700 South Patterson Blvd., Dayton, OH, 45479-0001, US

(73) Assignee: NCR Corporation

(21) Appl. No.: 11/065,664

(22) Filed: Feb. 24, 2005

Related U.S. Application Data
(60) Provisional application No. 60/547,109, filed on Feb. 24, 2004.

(51) Int. Cl. G06F 17/28; G06F 17/21

(52) U.S. Cl. 715/536; 704/2; 715/513

(57) ABSTRACT

A tool for finding and accurately translating matching English text fragments within web pages into a specified language from pre-translated text stored in a database table. The tool uses intelligent search patterns, like code prefixes and suffixes, to accurately find the matching text patterns and replace them. The algorithm pays special attention to sentence structure, syntax and vocabulary, and finds a suitable foreign language sentence or word corresponding to the matched English text.

### CROSS REFERENCE TO RELATED APPLICATIONS

This application is related to the following co-pending and commonly-assigned patent application, which is incorporated by reference herein:

Provisional Patent Application Ser. No. 60/547,109, entitled “DATA DRIVEN AUTOMATED INTERNATIONALIZATION,” by Ali Riaz, Dave Skura, Sam Safarian, Randy May, Fariba Haghighi and Naveed Khaliq; attorney docket number 11, 702; filed on Feb. 24, 2004.

### FIELD OF THE INVENTION

The present invention relates to methods and systems for building web-based applications for international markets, and more particularly, to a method for translating English language web pages to selected foreign languages.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Inferior forecasting science and gut feel decisions on inventory have created significant stock-out conditions across the industry. Recent studies quantify stock-outs in the retail industry at 5 to 8%, while overstock conditions caused by poor forecasts and buys continue to climb.

This challenge makes accurate consumer demand forecasting and automated replenishment techniques more necessary than ever. A highly accurate forecast not only removes the guess work for the real potential of both products and stores/distribution centers, but delivers improved customer satisfaction, increased sales, improved inventory turns and significant return on investment.

Teradata, a division of NCR Corporation, has developed a suite of analytical applications for the retail business, referred to as Teradata Demand Chain Management, that provides retailers with the tools they need for product demand forecasting, planning and replenishment. As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 103, organized into forecasting and planning applications 107 and replenishment applications 109, are:

Demand Forecasting: The Demand Forecasting module 111 provides store/SKU (Stock Keeping Unit) level forecasting that responds to unique local customer demand. It continually compares historical and current demand and utilizes several methods to determine the best product demand forecast.

Seasonal Profile: The Seasonal Profile module 113 automatically calculates seasonal selling patterns at all levels of merchandise and location, using detailed historical sales data.

Contribution: Contribution module 117 provides an automatic categorization of SKUs, merchandise categories and locations by contribution codes. These codes are used by the replenishment system to ensure the service levels, replenishment rules and space allocation are constantly favoring those items preferred by the customer.

Promotions Management: The Promotions Management module 119 automatically calculates the precise additional stock needed to meet demand resulting from promotional activity.

Automated Replenishment: Automated Replenishment module 121 provides suggested order quantities based on business policies, service levels, forecast error, risk stock, review times, and lead times.

Allocation: The Allocation module 123 determines distribution of products from the warehouse to the store.

The Teradata Demand Chain Management Solution interacts with users by allowing them to add, delete, and modify the data; perform varieties of business actions and planning via web screens such as grant/deny the user/group functional and data security access rights; submit business related jobs and define the policies etc. An example of an English language version of one of these web screens, page 201, is illustrated in FIG. 2.

The original DCM application is written in the English language and supports English characters and texts. However, the Teradata DCM Solution, like many other software applications, has a global customer base, requiring that the application support local languages in order to be understood and useful to customers from different countries and regions. Having a solution that enables the user to read in his or her preferred language immediately increases a user's level of comfort with the application and provides greater opportunities to utilize all of the features of Teradata Demand Chain Management solution. An improved, simple and efficient method for translating web pages into multiple languages for international users is desired.

### SUMMARY OF THE INVENTION

It is an object of the present invention to provide a new and useful system and method for translating application web pages for use in international markets

The method for translating application web page files constructed in a first language, such as English, comprises the steps of: establishing a computerized language database table containing a plurality of first language text fragments, and a second language text fragment corresponding to each one of said plurality of first language text fragments; successively examining web page files to identify web page files containing first language text fragments; saving electronic copies of said web page files that do not contain any first language text fragments to a target location within a web server; and for each one of said web page files that contains first language text fragments, substituting a corresponding second language text fragment for each one of said first language text fragments found in said one of said web page files to create a translated version of said one of said web page files, and saving said translated version of said one of said web page files to said target location.

The language database table may contain a plurality of additional language text fragments, for example, Spanish, French, German, etc., corresponding to each first language, or English, text fragment. The method would then necessarily also include the step of selecting the second language text fragments from said plurality of additional language text fragments contained within the language database table for use in the translation process.

Still other aspects of the present invention will become apparent to those skilled in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 provides an illustration of a forecasting, planning and replenishment software application suite for the retail industries built upon NCR Corporation's Teradata Data Warehouse.

FIG. 2 illustrates a portion of a web page utilized for entry of search criteria in the Teradata DCM Solution.

FIG. 3 is a flow diagram for a process for translating English text web pages to non-English languages in accordance with the present invention.

FIG. 4 illustrates a “PageText” database table for storing English text fragments along with non-English pre-translated equivalent language text fragments for use in translating web page languages in accordance with the present invention.

FIGS. 5A and 5B provide a flow diagram for a creation process which searches through English text web pages and generates records by file names, building a table of use in translating pages in accordance with the present invention.

FIG. 6 illustrates a “PageTextByFileNames” database table for storing translation text by file names to be used for converting web pages in accordance with the present invention.

FIGS. 7A and 7B provide a flow diagram for a conversion process which replaces web page contents by file names to create a translated set of web pages in accordance with the present invention.

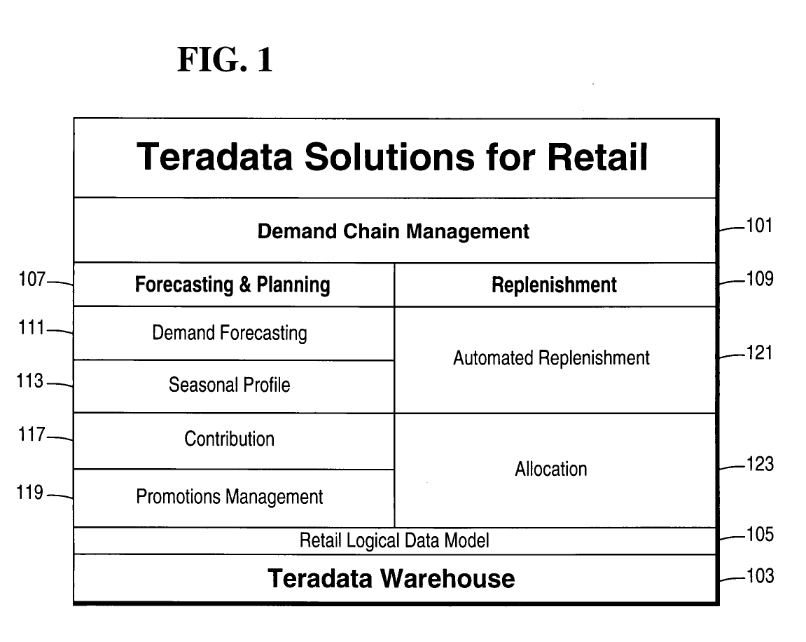

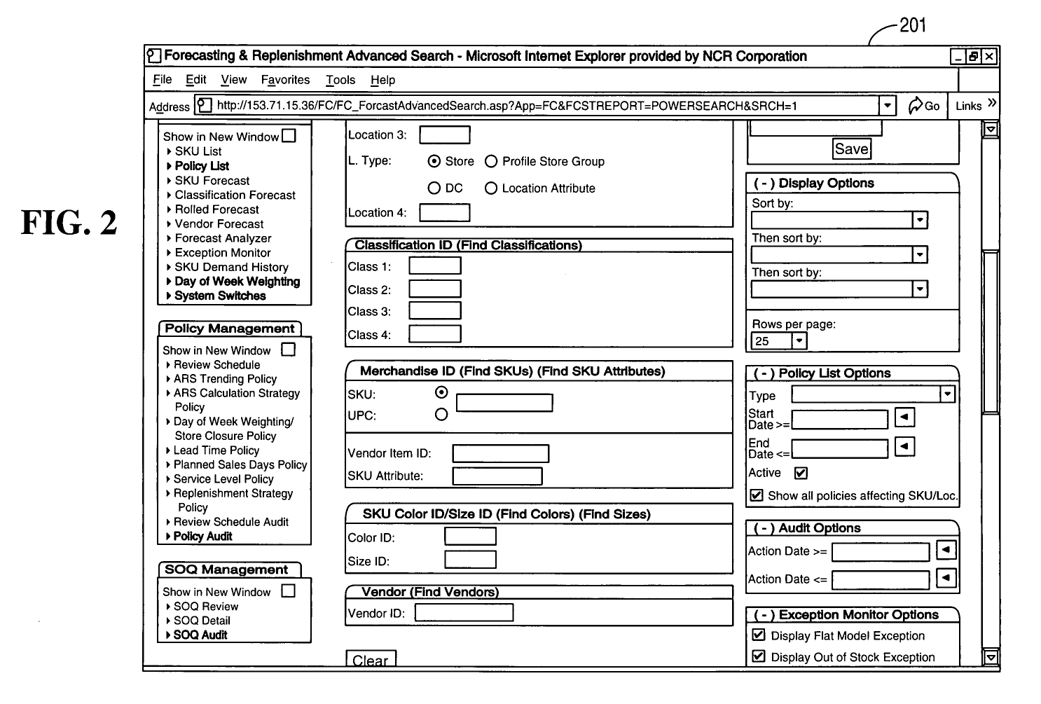

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

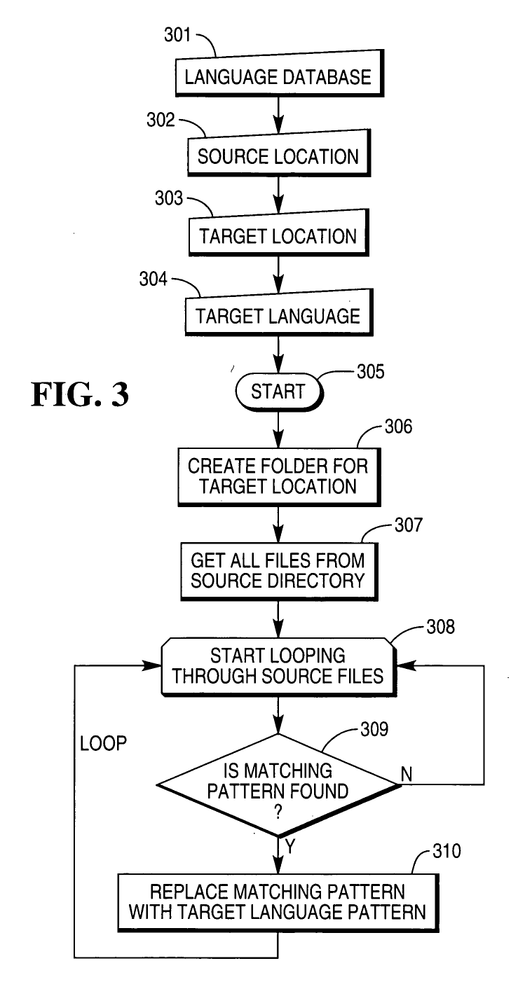

The method described herein is capable of translating web pages written in one language into a selection from many available languages, regardless of the number of pages or size of the pages. Referring to FIG. 3, a high-level flow diagram for a process for translating English text web pages to a selected non-English language is shown. The process uses a language database 301 to translate English language web pages stored in a source location 302, saving the translated pages to a target location 303 in a selected target language 304. The process begins by creating a folder for saving translated pages as shown in step 306. English text web pages retrieved from their source directory in step 307 are successively examined for matching English language text patterns.

The language database 301 contains pre-translated text along with corresponding English texts that exist in the source web pages. These text fragments could be labels, messages, titles or descriptions within the pages. The process loops through each and every file, which may have file extension such as .asa, .asp, .lbi, .js, and translates matched English language text into the specified target language, as shown in steps 308 through 310. It then makes copies of newly translated files into directories with the same structure which can be used for a specific client and language.

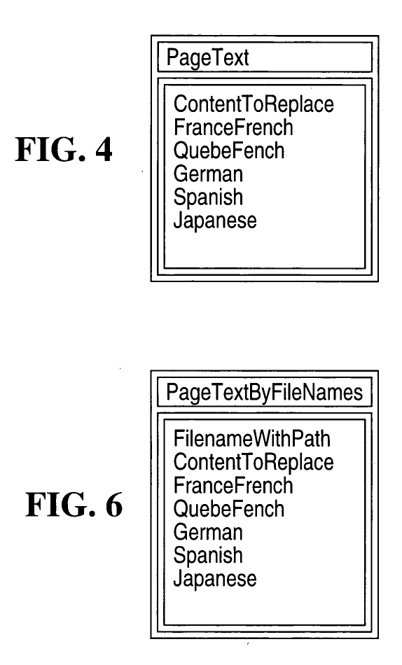

English text fragments and corresponding pre-translated text fragments for use in translating web page languages are stored within a “PageText” database table as shown in FIG. 4. The “ContentToReplace” column represents the English texts, whereas other columns are available to store the pre-translated text in specified languages. The table allows the user to add more languages as required.

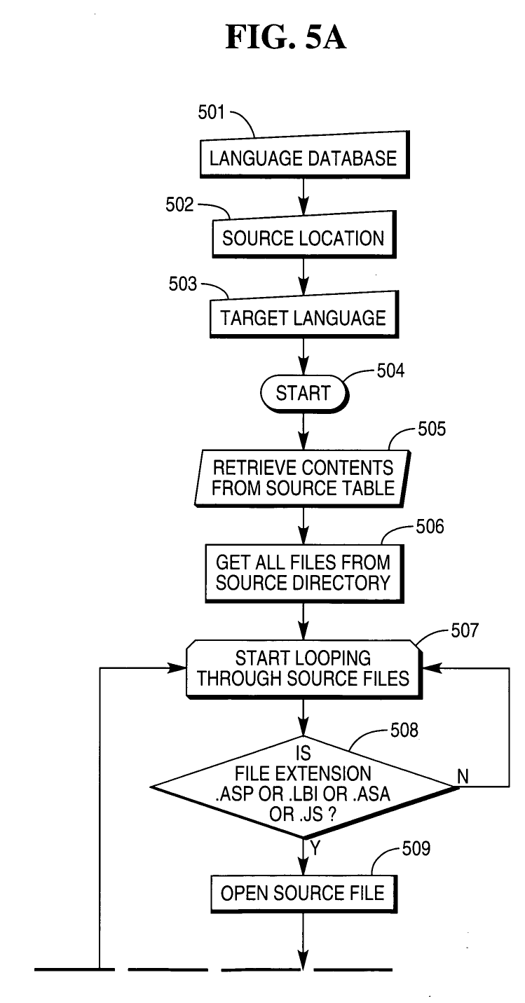

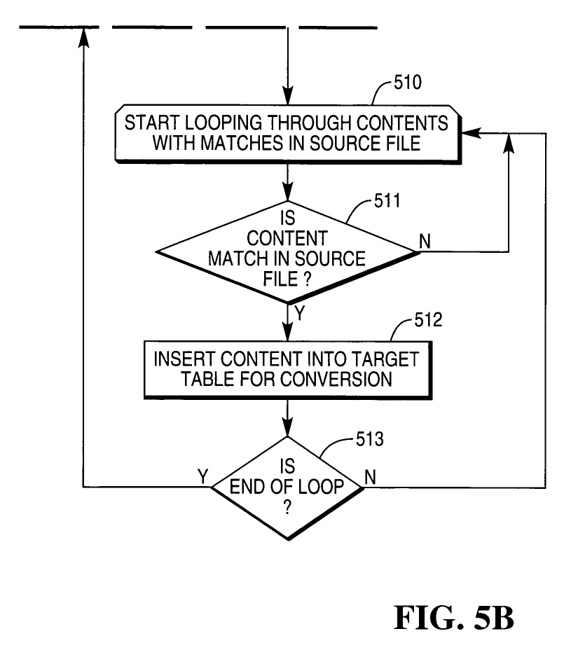

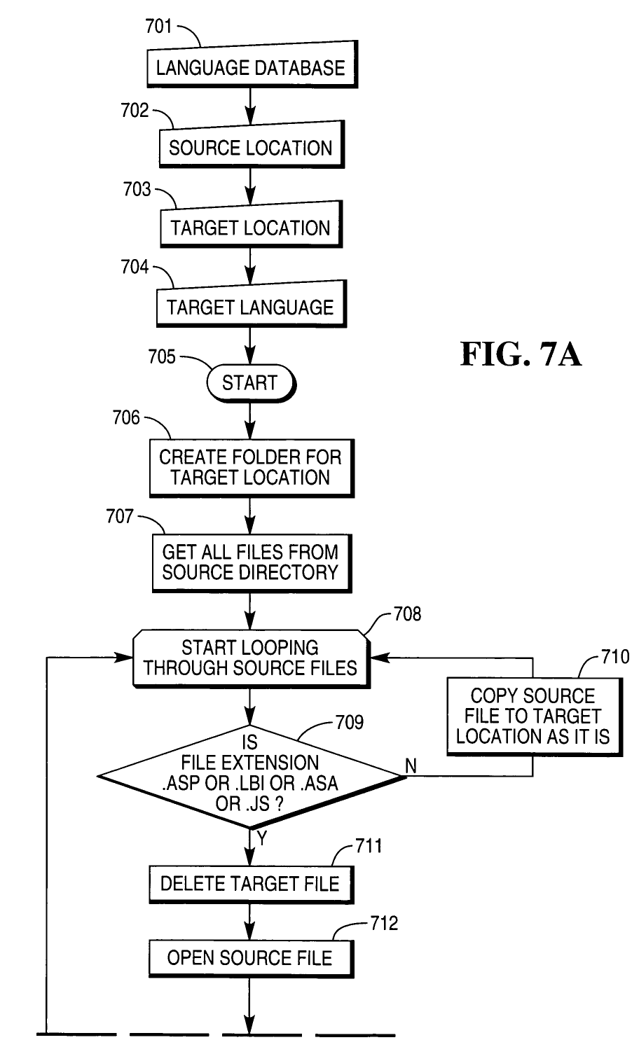

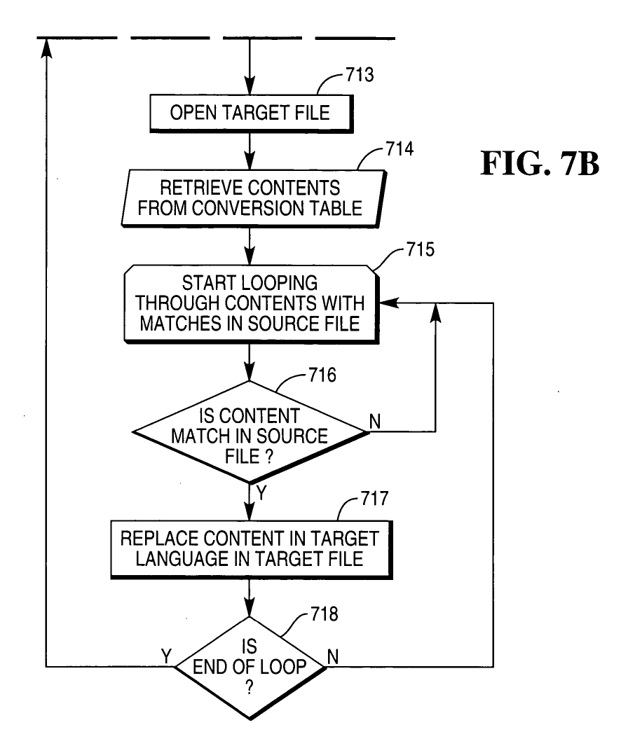

A more detailed process for translating web pages is shown in FIGS. 5 and 7. FIGS. 5A and 5B provide a flow diagram for a creation process which searches through English text web pages and generates records by file names, building a table of use in translating pages. The process retrieves translation text from the PageText database table, and English text web page files from their source directories as shown in steps 505 and 506. In steps 507 through 513, the process loops through each and every web page file retrieved from their source directories to identify text for conversion and builds a database table containing a listing of filenames and text to be converted, identified as table as “PageTextByFileNames” shown in FIG. 6.

FIGS. 7A and 7B provide a flow diagram for a conversion process which replaces web page contents by file names using the PageTextByFileNames database table of FIG. 6 to create a translated set of web pages. The process successively examines the English text web page files obtained from their source directories as shown in steps 708 through 709 to identify files requiring language conversion, e.g., files having filename extensions of .asp, .lbi, .asa or .js. In step 710, files that do not require translation are saved to a target location established in step 703 for the converted set of pages. In steps 711 through 717, the files identified for conversion are processed using the information contained within the PageTextByFileNames database table shown in FIG. 6 to replace matched English text with translated text. Converted files are saved to the target location. The process continues until all web pages requiring conversion have been translated.

### Conclusion

The web page conversion tool described above reads every ASP/LBI/JS/HTML file in an application and builds a translated version of the application using a language database. The version generator examines web pages for a text written under these conditions:
1) >text<
2) “text”
3) ‘text’
4) >text&
5) ;text<and
6) ;text&

The version generator will not replace any text which is written between “,” means comma or “(” means open bracket except .JS files because some text may have been written to pass to functions or represent a database field name. The tool is highly customizable for specific applications and users. Thus, it eliminates the task of running the translation application multiple times; a single run accomplishes this goal.

The foregoing description of various embodiments of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

1. A method for translating the text of a web page file constructed in a first language, comprising the steps of:
maintaining a computerized database table containing a plurality of first language text fragments, and a second language text fragment corresponding to each one of said plurality of first language text fragments;
electronically examining said web page file to identify first language text fragments contained therein; and
for each one of said first language text fragments found in said web page file, substituting a corresponding second language text fragment to create a translated version of said web page file.

2. The method in accordance with claim 1, wherein:
said computerized database table contains a plurality of additional language text fragments corresponding to each first language text fragment;
said method further comprising the step of selecting said second language text fragments from said plurality of additional language text fragments contained within said computerized database table.

3. The method in accordance with claim 1, wherein said first language comprises the English language, and said second language comprises a language other than the English language.

4. A method for translating the text of a plurality of web page files constructed in a first language, said plurality of web page files stored in a source location within a web server, the method comprising the steps of:
maintaining a computerized database table containing a plurality of first language text fragments, and a second language text fragment corresponding to each one of said plurality of first language text fragments;
successively examining said web page files to identify web page files containing first language text fragments;
saving electronic copies of said web page files that do not contain any first language text fragments to a target location within said web server; and
for each one of said web page files that contains first language text fragments, substituting a corresponding second language text fragment for each one of said first language text fragments found in said one of said web page files to create a translated version of said one of said web page files, and saving said translated version of said one of said web page files to said target location.

5. The method in accordance with claim 4, wherein:
said computerized database table contains a plurality of additional language text fragments corresponding to each first language text fragment;
said method further comprising the step of selecting said second language text fragments from said plurality of additional language text fragments contained within said computerized database table.

6. Apparatus for translating the text of a plurality of web page files constructed in a first language, said plurality of web page files stored in a source location within a web server, the apparatus comprising:
a computerized database table containing a plurality of first language text fragments, and a second language text fragment corresponding to each one of said plurality of first language text fragments;
means for successively examining said web page files to identify web page files containing first language text fragments;
means for saving electronic copies of said web page files that do not contain any first language text fragments to a target location within said web server; and
for each one of said web page files that contains first language text fragments, means for substituting a corresponding second language text fragment for each one of said first language text fragments found in said one of said web page files to create a translated version of said one of said web page files, and saving said translated version of said one of said web page files to said target location.

7. The apparatus in accordance with claim 6, wherein:
said computerized database table contains a plurality of additional language text fragments corresponding to each first language text fragment;
said apparatus further comprises means for selecting said second language text fragments from said plurality of additional language text fragments contained within said computerized database table.
